(19) United States
(12) Patent Application Publication
(10) Pub. No.: US 2016/0178124 A1
(43) Pub. Date: Jun. 23, 2016

(54) Oil and Grease Recovery Device

(71) Applicant: HalenHardy, LLC, Bellwood, PA (US)

(72) Inventor: Donald L. Beaver, Bellwood, PA (US)

(21) Appl. No.: 14/998,348

(22) Filed: Dec. 28, 2015

Related U.S. Application Data
(60) Provisional application No. 62/162,332, filed on May 15, 2015.
(60) Provisional application No. 62/157,029, filed on May 5, 2015.
(60) Provisional application No. 62/095,915, filed on Dec. 23, 2014.

(51) Int. Cl. F16N 31/00; E02D 31/00

(52) U.S. Cl. CPC F16N 31/006; E02D 31/00

(57) ABSTRACT

A system for collecting machine fluid includes a base and a berm that form a fluid collection cavity. The base includes an adsorbent pad that is oleophilic and water-permeable. The berm encloses a perimeter of the base and includes a core formed of a flexible material that is water-permeable, as well as a supporting layer that is rolled with the flexible material to provide a cylindrical core of alternating layers of two different water-permeable materials, at least one of which is oleophilic.

### RELATED APPLICATIONS AND CLAIM OF PRIORITY

This patent document claims priority to: (i) U.S. Provisional Patent Application No. 62/095,915, filed Dec. 23, 2014; (ii) U.S. Provisional Patent Application No. 62/157,029, filed May 5, 2015; and (iii) U.S. Provisional Patent Application No. 62/162,332, filed May 15, 2015. The disclosures of all of the priority applications are incorporated herein by reference in their entireties.

### BACKGROUND

The present disclosure relates to a system for collecting oil-containing and/or grease-containing fluids and filtering water from the oil or grease.

The collection of machine fluids that drip from pumps, motors, vehicle and other machinery is critical to preventing soil and groundwater contamination. If machine fluids are not collected, oil, grease and other contaminants in the fluids can enter the environment.

Conventional grease and oil collection trays exhibit several disadvantages. For example, when a catch tray is placed in an outdoor location, rainwater can quickly overload the device. In addition, some of the hydrocarbons from the grease float to the top of the water and create water with an oily sheen. As precipitation continues, this water with an oily sheen runs out of the tray and onto the ground, creating further contamination.

Other devices have limited lifespans and cannot be re-used. When the device becomes saturated with oil, the entire device must be discarded, creating additional waste.

The present disclosure describes a system directed to solving at least some of the problems described above.

### SUMMARY

In an embodiment, a system for collecting machine fluid includes a base and a berm that form a fluid collection cavity. The base includes an adsorbent pad that is configured to retain or reject oils while allowing water to pass through. The berm encloses a perimeter of the base, and it includes a core formed of a flexible material that is oleophilic (retains oils) and water-permeable (allows filtered water to pass through). The core may include alternating layers of the flexible material and a supporting material, rolled in a cylindrical form. The supporting material may optionally also be oleophilic, but different from the oleophilic material of the adsorbent pad.

Optionally, the base may include a screen that is positioned over or under all or a portion of the adsorbent pad. The base may also include an impermeable bottom layer under the adsorbent pad.

The adsorbent pad and/or supporting material may comprise a cellulosic material, a polyester material, or a blend of polyester with cellulosic material. Alternatively, the pad and/or supporting material may be made of polypropylene or another material that retains oil but allows filtered water to pass through it.

The adsorbent pad may be removable from the base and collection area and reuseable. In some embodiments, the berm and the base may be integrally connected. An impermeable skin may cover a bottom portion of the base.

### BRIEF DESCRIPTION OF THE DRAWINGS

FIG. 1 is a top perspective view of an oil collection and oil-water filtering device.

FIG. 2 is a cross-sectional view of the device of FIG. 1.

FIG. 3 is partial sectional side view of an alternative device.

FIG. 4 describes an alternative oil collection and oil-water filtering device.

FIG. 5 illustrates an embodiment of a berm of the device in certain embodiments.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. All sizes recited in this document are by way of example only, and the disclosure is not limited to structures having the specific sizes or dimensions recited below. As used in this document, the term “comprising” means “including, but not limited to.”

In consideration of the figures, it is to be understood for purposes of clarity that certain details of construction and/or operation are not provided in view of such details being conventional and well within the skill of the art upon disclosure of the document described herein.

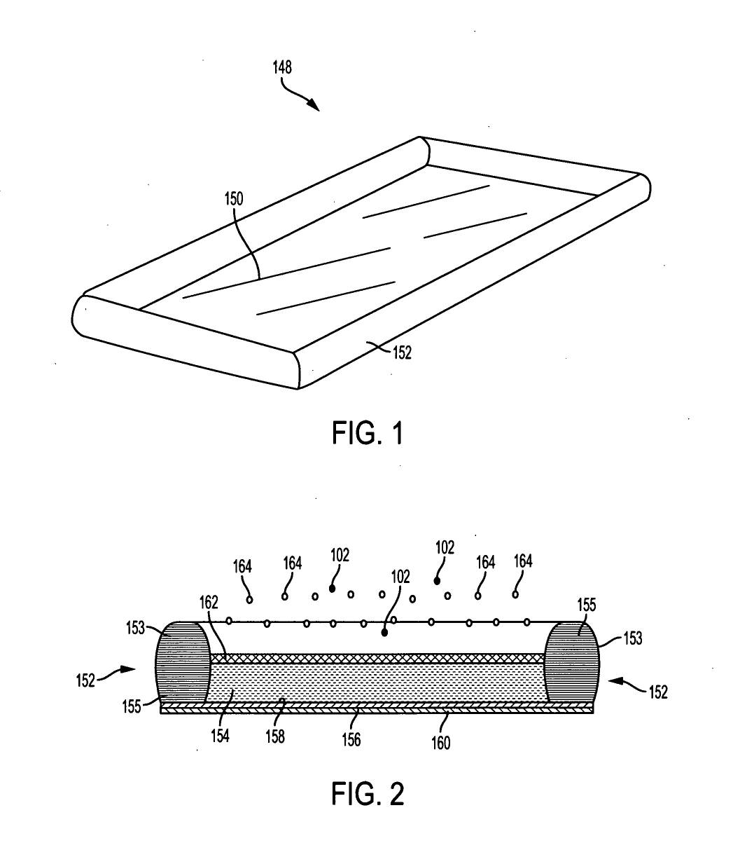

FIG. 1 is a top perspective view of an oil-water collection and filtering device 148 in one embodiment. FIG. 2 is a cross-sectional view of the oil-water collection and filtering device of FIG. 1. In one embodiment, the device 148 includes a substantially flat collection surface 150 and a berm 152 (i.e., a sidewall) connected to and positioned to surround the perimeter of the collection surface 150. The device 148 may be of any suitable shape and size to fit under the fluid-expelling machinery with which it is used. The berm 152 may be configured as a flexible, fabric tubular or cylindrical structure 153 containing an absorbent or adsorbent material 155 such as polyester fibers or other materials (manmade or natural) that are rigid, self-supporting and resilient to ensure sufficient rigidity as a self-supporting structure in use. The height of the berm 152 may be generally about 1.97 inches to about 3.94 inches, although other sizes are possible. The berm 152 may be formed with (e.g., molded) or attached to a flattened base 158 so that it may be attached to the periphery of the collection surface 150.

The collection surface 150 may be positioned over (and may optionally include) an impermeable base layer 160 made of plastic, vinyl, polyethylene, urethane-coated polyester or canvas, or another impermeable material. Over the base layer 160, an optionally removable fabric layer 154 may include a layer of a water-permeable, olephilic material, such as a fibrous polyester material, a cellulosic material, or a blend of polyester with cellulosic material. Alternatively, the fabric layer 154 may be made of polypropylene or another material that retains oil but allows filtered water to pass through it. In one embodiment, the material of the fabric layer 154 may also be used to form some or all the tubular structure of the berm 152. The fabric layer 156 serves as an adsorbent pad and may be fixed to the structure as shown in FIG. 2, or it may be removable from the top of the device. An optional screen material 158 that is water- and oil-permeable, such as a different fibrous polyester material, may be positioned over or under the adsorbent pad to filter large particles.

In some embodiments, the berm 152 may be formed of a core, with an oleophilic (oil-retaining or which otherwise does not typically permit oil to pass unless and until saturated) material wrapped around the core. A permeable supporting fabric (such as netting or screen material) may be formed around the oleophilic material to retain the oleophilic material in place. The core may be made of an open cell foam that allows water to pass through, such as quantum foam, polyurethane foam or foam rubber, extruded polystyrene (XPS) foams, phenolic foam and the like. In other embodiments, the berm 152 may be formed of alternating layers of oleophilic material and supporting material, rolled about a central axis. (An example of this is shown in FIG. 5.) The central axis may be a foam core, or it may simply be an end of one or both of the layers of material of the permeable fabric layer 156 or the optional screen material 158.

When positioned under an item of machinery, excess or leaky machine fluid or oil (shown as black drops 102) falls into the oil-water filtering area of the device 148. An oil layer 162 is formed in a collection area defined by the collection surface and the berm. If water falls into the device, such as in the case of rainfall (shown as white drops 164), the water may accumulate in the device 148 underneath the oil layer 162. The liquids flow into the berm 152. where the oil 102 is attracted to and retained by the polyester fibers or other suitable oleophilic materials, while the water passes through the fibers of the berm 152 and exits the berm and drains away. In some embodiments, oil 102 may enter the adsorbent pad layer 154 in the collection surface 150 and remain there.

The collection surface 150 may be regenerated by passing the adsorbent pad 154, or the entire device, between rollers to squeeze any retained oil out of the material of the collection surface. Through this process, machine fluid may be expelled from the device and then collected and disposed. The pad or entire device may be mechanically squeezed, centrifuged, dry cleaned with mineral spirits, and/or washed with detergent and water to remove any residual machine fluid and to ready it for re-use.

In some embodiments, the collection surface 150 may be formed of a separable material (such as a reusable or disposable adsorbent pad) that may be removed for cleaning and/or discarding. If so (or even if not), the collection surface 150 and/or a layer underneath it may be formed of any suitable oleophilic and water-permeable material so that it adsorbs oil and grease but passes water. Examples include a blend of polyester and cellulosic fibers, such as are used in carpet manufacturing. Examples of such materials are disclosed in U.S. Pat. No. 6,562,938 and International Patent Application No. PCT/US2000/004181, the disclosures of which are fully incorporated by reference. In one embodiment, the adsorbent layer may be formed of recycled carpet material.

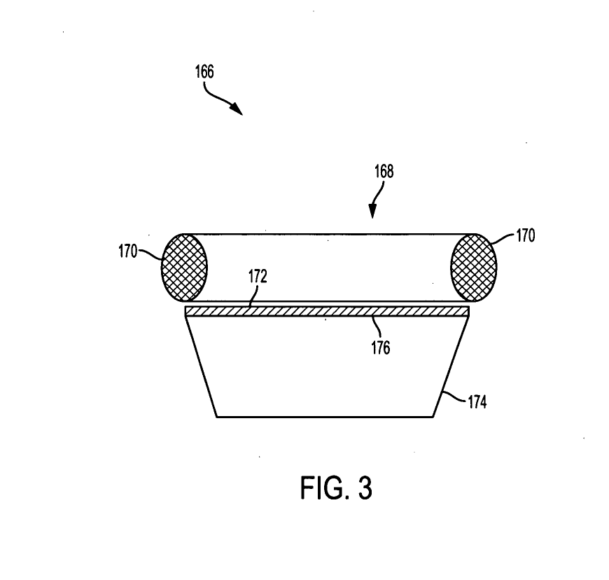

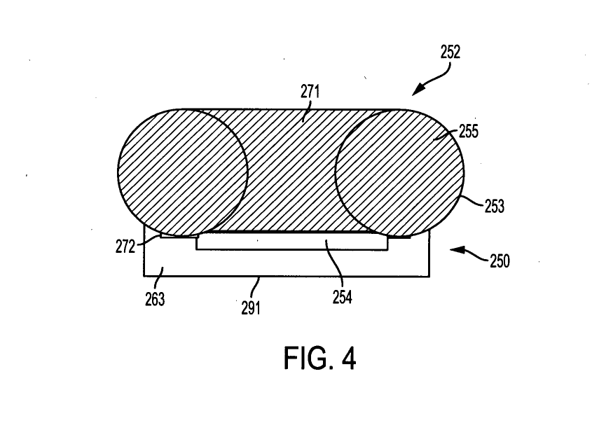

FIG. 3 is partial sectional side view of an alternative oil-water separator and filtration device 166 that may be used with the system 100 of the present disclosure. This embodiment of the device 166 is configured similarly as the device 148 of FIGS. 1-2 having a geometrically shaped, substantially flat collection surface 168 formed with a berm 170 around its perimeter. The collection surface 168 is formed of a base layer 172 having a layer of an oil- and water-permeable material and the berm 170 having a layer of water-permeable, oleophilic material in which machine fluid 102 falling on the collection surface 168 passes through the base layer and water falling on the collection surface 168 exits through the berm 170. This embodiment of the device 166 further includes a portable collector for machine fluids including an open tank 174, a mesh plate 176 positioned on top of the open tank 174, and a collection surface 168 with a berm 170 as described above positioned on the mesh plate 176. In operation, the device 166 may be positioned directly underneath the machinery to collect machine fluids that fall from the device.

In some embodiments, the permeable material forming the base layer 172 includes a felt material with a fabric cover. The felt material may be fabricated of any suitable permeable material, including polytetrafluoroethylene (PTFE) fibers. The oleophilic material forming the berm 170 may be fabricated of fibers of an oily plastic material, such as polyolefin. The water-permeable fibers may be formed from suitable polymers set forth above or as a fiber coating, by plasma deposition, surface modification, or by a sol-gel process. Optionally, a layer of the oleophilic material of the berm may be positioned over the mesh plate 176 to filter machine fluids from the water that passes into the tank.

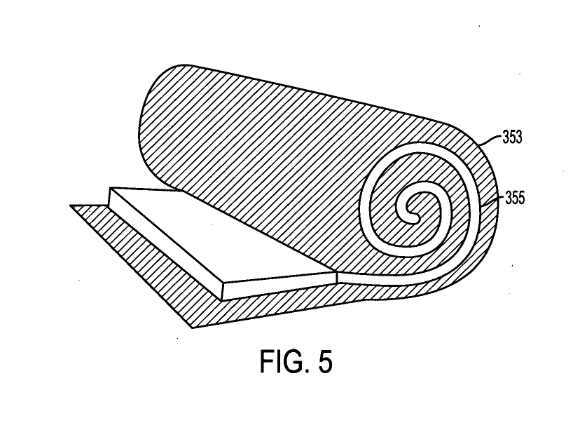

FIG. 4 shows an alternate embodiment in which a berm 252 and base 250 form a cavity 271 that provides a containment area for the collection of machine fluids. The berm may include a core made of an adsorbent, oleophilic, water-permeable material 255 such as the polyester/cellulose blend described above. Other suitable materials are disclosed in U.S. Patent Application Pub. No. 2012/0241460; U.S. Pat. No. 4,199,447; and U.S. Pat. No. 3,804,661, the disclosures of which are each fully incorporated herein by reference. The core may be surrounded by a screen 253 made of a porous material such as PVC-coated polyester or another suitable supporting material.

Optionally, as shown in FIG. 5, the core may be formed of a roll of spiraled, alternating layers of the adsorbent material 355 and a supporting material 353. Both of the materials 353, 355 will be water-permeable, and a least one of the two material layers 353, 355 shown in FIG. 5 will be oleophilic. Optionally, both layers may be 353, 355 oleophilic, although made of different olephilic materials, such as different fibrous materials, fiber materials and foam materials, various cellulosic materials, and/or various polyester materials.

Returning to FIG. 4, the base 250 may be made of a screen 263 (such as those described above) and/or an impermeable skin 291 made of a material such as plastic, vinyl or the like. The removable adsorbent pad 254 may be placed in the center of the base and at the bottom of the containment area 271. The screen 263 may surround all or part of the pad 254. Optionally, multiple pad/screen layers may be stacked in the cavity. The pad 254 (optionally with it screen) may be removed from the cavity and cleaned by wringing, pressing, centrifuging and/or other processes.

The berm 252 may be separably attached to the base 250 via one or more fasteners 272 such as a hook-and-loop material, a zipper, snaps, clips, or an impermeable connection such as a sliding zip lock closure. Alternatively, the berm 252 and base 250 may be integrally formed as a single structure, some or all of which may be surrounded by the impermeable skin 291 on its exterior walls.

The features and functions described above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for collecting machine fluid, comprising:
a collection area comprising:
an adsorbent pad comprising an oleophilic and water-permeable material, and
a base positioned below the adsorbent pad;
a berm that is positioned over and attached to the base, that encloses a perimeter of the base, and that comprises a core having a roll of spiraled, alternating layers of:
the oleophilic and water-permeable material, and
a water-permeable supporting material.

2. The system of claim 1, wherein the supporting material is also oleophilic but is different from the oleophilic material of the adsorbent pad.

3. The system of claim 1, further comprising a screen that surrounds the core.

4. The system of claim 1, further comprising a screen layer positioned over or under the adsorbent pad.

5. The system of claim 1, wherein the adsorbent pad comprises a cellulosic material or a polyester material.

6. The system of claim 1, wherein the adsorbent pad comprises a polyester material blended with a cellulosic material.

7. The system of claim 1, wherein the adsorbent pad is removable from the collection area and reuseable.

8. The system of claim 1, wherein the berm is connected to but removable from the base.

9. The system of claim 1, wherein the base comprises an impermeable layer that forms a bottom portion of the base.

10. The system of claim 1, further comprising a tank positioned below the base.

11. A system for collecting machine fluid, comprising:
a base comprising:
an adsorbent pad comprising an oleophilic and water-permeable material, and
an impermeable skin that covers a bottom portion of the base;
a berm that is attached to a perimeter of the base, and that comprises a core formed of a roll of spiraled, alternating layers of:
the oleophilic and water-permeable material, and
a water-permeable supporting material.

12. The system of claim 11, wherein the supporting material is also oleophilic but is different from the oleophilic material of the adsorbent pad.

13. The system of claim 11, further comprising a screen layer positioned over or under the adsorbent pad.

14. The system of claim 11, wherein the adsorbent pad comprises a cellulosic material or a polyester material.

15. The system of claim 11, wherein the adsorbent pad comprises a polyester material blended with a cellulosic material.

16. The system of claim 11, wherein the adsorbent pad is removable from the collection area and reuseable.

17. The system of claim 11, further comprising a tank positioned below the base.

18. A system for collecting machine fluid, comprising:
a base comprising a removable adsorbent pad comprising an oleophilic and water-permeable material, wherein the material comprises a cellulosic material or a polyester material;
a screen that is positioned over or under a portion of the adsorbent pad; and
a berm that is attached to a perimeter of the base, and that includes a core that comprises a roll of spiraled, alternating layers of:
the oleophilic and water-permeable material, and
a water-permeable supporting material.

19. The system of claim 18, wherein the supporting material is also oleophilic but is different from the oleophilic material of the adsorbent pad.
